(19) United States
(12) Patent Application Publication
(10) Pub. No.: US 2026/0222399 A1
(43) Pub. Date: Jul. 30, 2026

(54) DATA ACCESS AUTHENTICATION

(71) Applicant: Honeywell International Inc., Charlotte, NC (US)

(72) Inventors: Ankit Singh, Apex, NC (US); Lakshminarayana Paila, Frisco, TX (US)

(21) Appl. No.: 19/035,948

(22) Filed: Jan. 24, 2025

(51) Int. Cl. H04L 9/40; G06F 9/54

(52) U.S. Cl. CPC H04L 63/083; G06F 9/547

(57) ABSTRACT

Approaches for efficient data access authentication during user sessions established with a first client application controlled by a server are described. The approach involves generating, by the server, a unique, obfuscated claim set for each user session requested to be established by a user with the client application. The obfuscated claim set is derived based on a set of attributes, including user-specific attributes, session-specific attributes, and historical attributes. The obfuscated claim set derived by the server is to be provided to the first client application for being used for data access authentication during the user session. For every application programming interface (API) call received from the first client application to access protected data during the user session, access to the protected data is controlled by the server based on a comparison of a claim set received within the API call with the obfuscated claim set.

### BACKGROUND

Generally, organizations across various industries frequently need to disseminate sensitive information to specific stakeholders, including customers, partners, suppliers, and regulatory bodies. However, while disseminating the sensitive information, the organizations also need to take safety measures to avoid data breach. The organizations are thus faced with the challenge to efficiently deliver confidential data to an intended user while protecting the confidential data from interception or misuse. For example, while a pharmaceutical company may need to notify specific healthcare providers about a drug recall, the pharmaceutical company also needs to ensure data confidentiality so that the critical information about the drug recall reaches only authorized recipients. Similarly, a financial institution may need to send account statements or fraud alerts to individual customers without risking exposure of any sensitive information, including identity of the customer, to unauthorized parties.

The adoption of internet-hosted software solutions, such as cloud-based applications, for disseminating the sensitive information has experienced exponential growth. The internet-hosted software solutions may be easily accessed using a variety of devices, such as desktops and mobile devices, and by a variety of users, such as employees, partners, and customers. Although the internet-hosted software solutions offer unprecedented accessibility, flexibility, and scalability, the internet-hosted software solutions have introduced new challenges in securing access to the sensitive information. Therefore, there is a need for efficient data access authentication techniques to prevent unauthorized access of sensitive information using the internet-hosted software solutions.

### BRIEF DESCRIPTION OF FIGURES

Systems and/or methods are now described, in accordance with examples of the present subject matter and with reference to the accompanying figures, in which:

FIG. 1 illustrates a system comprising a server for data access authentication, according to an example;

FIG. 2 illustrates a computing environment implementing the server for data access authentication, according to another example;

FIG. 3 illustrates an exemplary data flow representing communication between various computational entities of the computing environment for data access authentication, according to an example;

FIG. 4 illustrates a computing environment implementing a private cluster for data access authentication, according to an example;

FIG. 5 illustrates a method for data access authentication, according to an example;

FIG. 6 illustrates a method for data access authentication, according to another example;

FIG. 7 illustrates a method for data access authentication, according to yet another example;

FIG. 8 illustrates a method for notifying one or more users to access protected data, according to an example;

FIGS. 9A and 9B illustrate a method for authenticating a session establishment request initiated for establishing a user session to access protected data, according to an example; and

FIG. 10 illustrates a computing environment implementing a non-transitory computer-readable medium for data access authentication, according to an example.

### DETAILED DESCRIPTION

Typically, a server-client architecture forms the backbone of systems deployed for controlling access to sensitive information. The server-client architecture defines that a server may act as an authoritative source and guardian of sensitive information, while a client application, controlled by the server, may serve as an interface through which users access the sensitive information. The users may request the server to access sensitive information using the client application. Based on a data access authentication technique, the server may verify the request and accordingly control access to the sensitive information. For instance, a corporate server may regulate employee access to confidential documents via a secure file-sharing application. Similarly, a healthcare provider's server may control patient data access through a mobile application, allowing doctors to retrieve medical records.

According to a traditional data access authentication technique, web tokens, such as JavaScript Object Notation (JSON) Web Tokens (JWTs), may be used for data access authentication. The server may generate a JSON Web Token (JWT) and may transmit the JWT to the client application through which a user is trying to access a particular data. The JWT may include a static set of claims, such as a name of the user, an address of the user, and a phone number of the user. For requesting access to the particular data, the client application needs to transmit a web token to the server, where the web token should include the fixed set of claims that were received from the server in the JWT. Only when the web token received at the server includes claims that are same as the claims transmitted by the server to the client application, the server may grant access to the particular data. If the web token includes different claims than the claims transmitted by the server, the server may not allow access to the particular data. The client application may use a web token including claims whenever some confidential information is to be accessed by the user through the client application. According to the traditional data access authentication technique, the set of claims transmitted by the server to the client application remain same every time the user logs in to the client application.

The static set of claims within JWTs are vulnerable to theft and reuse by unauthorized users, such as hackers or other bad actors. Once compromised, the static set of claims can be used by attackers until expiration, which may be a significant window of opportunity for gaining access to sensitive information or modifying the sensitive information. For instance, a token granting access to sensitive financial data remains valid even if location of data access changes. The attackers may decode the static set of claims and may keep using the static set of claims subsequently multiple times to gain access to the sensitive information.

Moreover, the JWTs are stored in a client-side storage, such as session storage, where the client application is being accessed, thereby increasing the risk of theft of the JWT. The client-side storage is inherently less secure than server-side storage, as the client-side storage is more accessible to potential attackers. Persisting the JWTs in the client-side storage may lead to cross-site scripting (XSS) attacks. If a malicious user gains access to the client-side storage, the malicious user may extract the JWTs. Since the claims are static, the malicious user may reuse the JWTs to impersonate a legitimate user, potentially for extended periods if the JWTs have a long expiration time. Therefore, there is a need for efficient data access authentication techniques that prevent access to sensitive information.

The present subject matter describes approaches for efficient data access authentication during user sessions established with a first client application controlled by a server. The approach involves generating, by the server, a unique, obfuscated claim set for each user session requested to be established by a user with the client application. The obfuscated claim set is derived based on a set of attributes, including user-specific attributes, session-specific attributes, and historical attributes. The user-specific attributes may be attributes describing the user. The session-specific attributes may be attributes describing a current context of interaction with the first client application. The historical attributes may be confidential attributes historically provided to the server by the user or another entity associated with the user session. The obfuscated claim set derived by the server is to be provided to the first client application for being used for data access authentication during the user session. For every application programming interface (API) call received from the first client application to access protected data during the user session, access to the protected data is controlled by the server based on a comparison of a claim set received within the API call with the obfuscated claim set. Thus, the present subject matter provides an approach to generate a dynamic, session-specific claim set that is much harder to predict or reuse. The obfuscated claim set is derived based on a combination of attributes that is not easy to predict. The present subject matter therefor allows for fine-grain data access control preventing any malicious user from gaining unauthorized access to the protected data.

In an example, the set of attributes may be obtained, and the obfuscated claim set may be derived by the server upon ascertaining authenticity of a session establishment request received from the user. The session establishment request may be a request for establishing the user session with the first client application. To ascertain whether the session establishment request is authentic, an authentication process may be initiated.

In an example, according to the authentication process, request-specific data associated with the session establishment request may be obtained. The request-specific data may include at least one of an access code included in the session establishment request, contact information associated with the session establishment request, a session-specific attribute associated with the session establishment request, and a request attribute describing the session establishment request. Further, login-specific data associated with a login request, received at the server from the user prior to the session establishment request, may be obtained. The login request may be a request to login into the first client application. The login-specific data may include at least one of a temporary code, contact information corresponding to the user, at least one session-specific attribute describing a current context of interaction with the first client application, and at least one login attribute describing the login request. The temporary code may be generated and transmitted by the server to the user for future use by the user to trigger the session establishment request.

Once the request-specific data and the login-specific data are obtained, the request-specific data and the login-specific data may be analyzed by the server to ascertain whether the session establishment request is authentic. For example, the session establishment request may be ascertained to be authentic when the request-specific data is same as the login-specific data.

In an example, upon ascertaining the session establishment request to be authentic, the set of attributes may be obtained, and the obfuscated claim set may be derived by the server. Subsequently, a session-specific token, corresponding to the user session, incorporating the obfuscated claim set may be generated by the server. The session-specific token may then be encoded to generate an encoded session-specific token. For ensuring secure transmission of the session-specific token, the encoded session-specific token may be embedded within a session cookie, such as a Hypertext Transfer Protocol Secure (Https) cookie, for transmission to the first client application. The session cookie may then be transmitted to the first client application. The session-specific token within the session cookie may be utilized by the first client application for generating call-specific tokens for data access authentication during the user session.

In an example, for accessing protected data, the user may trigger a particular API call to the server using the first client application. The particular API call to access specific protected data during the user session may be received at the server. The particular API call may include a call-specific cookie including an encoded call-specific token. The encoded call-specific token may be extracted from the call-specific cookie and may be decoded to derive a particular claim set included in the encoded call-specific token. The particular claim set may be compared by the server with the obfuscated claim set to ascertain whether the particular claim set is valid. Upon ascertaining the particular claim set to be valid, access to the specific protected data may be granted. Upon ascertaining the particular claim set to be invalid, access to the specific protected data may be restricted.

The use of dynamically generated, obfuscated claim sets for each user session provides a robust defence against token theft and replay attacks. Unlike static tokens, the present subject matter provides the session-specific tokens with unique claim sets that are much harder for attackers to predict. The obfuscation of claims within the session-specific tokens adds an extra layer of security, making it extremely difficult for unauthorized parties to decipher contents of the session-specific tokens even if intercepted. The present subject matter thus significantly reduces the risk of unauthorized access through stolen or compromised tokens.

The present subject matter incorporates various attributes, including user-specific attributes, session-specific attributes, and confidential historical attributes, into the claim set which may not make any sense to the attackers, thereby allowing for highly granular and adaptive data access control. The present subject matter thus provides a dynamic approach that enables the server to make real-time decisions about data access authorization quickly and efficiently.

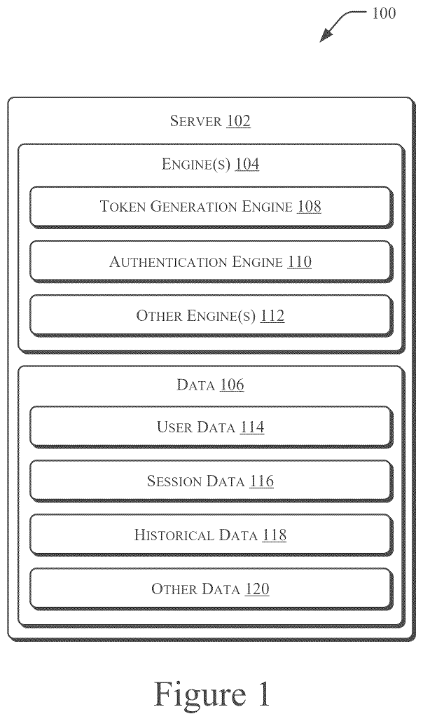

The present subject matter is further described with reference to FIG. 1 to FIG. 10. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a system 100 for data access authentication, according to an example. In one example, the system 100 may be a distributed computing system having one or more physical computing systems geographically distributed at same or different locations. In another example, one or more components of the system 100 may be hosted virtually, for example, on a cloud-based platform, while other components may be geographically distributed at same or different locations. In yet another example, the system 100 may be a stand-alone physical system geographically located at a particular location.

In an example, the system 100 may comprise a server 102. The server 102 may be configured to control user sessions established with a first client application. The first client application may serve as an interface through which users may access protected data based on data access authentication implemented by the server 102. In one example, a particular user may interact with the first client application by installing a version of the first client application as a software application on a user device, such as a desktop computer, a laptop, a tablet, a smartphone, and a wearable device. In another example, the particular user may interact with the first client application by accessing a version of the first client application as a website on the user device. In an example, for accessing the protected data, the user may issue a data access request to the server 102 using the first client application. The server 102 may implement data access authentication to control access to the protected data based on authentication of the data access request.

In one example, the server 102 may include engine(s) 104 and data 106. The server 102 may also include additional components, such as display, input/output interfaces, operating systems, applications, and other software or hardware components (not shown in the figures).

The engine(s) 104 may be implemented as a combination of hardware and programming, for example, programmable instructions to implement a variety of functionalities of the engine(s) 104. In examples described herein, such combinations of hardware and programming may be implemented in several different ways. For example, the engine(s) 104 may be programmed using executable instructions. Such instructions may be stored on a non-transitory machine-readable storage medium which may be coupled either directly with the server 102 or indirectly (for example, through networked means). In an example, the engine(s) 104 may include a processing resource, for example, either a single processor or a combination of multiple processors, to execute such instructions. In the present examples, the non-transitory machine-readable storage medium may store instructions that, when executed by the processing resource, implement the engine(s) 104. In other examples, the engine(s) 104 may be implemented as electronic circuitry.

In one example, the engine(s) 104 may include a token generation engine 108, an authentication engine 110, and other engine(s) 112. The other engine(s) 112 may further implement functionalities that supplement functions performed by the server 102 or any of the engine(s) 104.

The data 106 includes data that is either received, stored, or generated as a result of functions implemented by any of the engine(s) 104 or the server 102. It may be further noted that information stored and available in the data 106 may be utilized by the engine(s) 104 for performing various functions of the server 102. The data 106 may include user data 114, session data 116, historical data 118, and other data 120. The user data 114 may include data associated with users that are authorized to interact with the first client application or any other client application hosted by the server 102. The session data 116 may include data associated with user sessions established or to be established with the first client application or any other client application hosted by the server 102. The historical data 118 may include confidential information historically provided to or collected by the server 102 from the authorized users or other entities associated with the user sessions. The historical data 118 may include any other confidential information, directly or indirectly related to the authorized users or the user sessions, available to the server 102. The other data 120 may include data that is either received, stored, or generated as a result of functions implemented by any of the engine(s) 104.

In operation, for enabling data access authentication, the token generation engine 108 may obtain a set of attributes corresponding to a user session requested to be established by a user with the first client application. In one example, the set of attributes may be obtained by querying an internal database of the server 102. For instance, the set of attributes may be selected from data stored within the user data 114, session data 116, and the historical data 118. In another example, the set of attributes may be obtained from external sources, such as the user, another entity associated with the user session, or an external database within which confidential information pertaining to the user or the user session may be stored.

The set of attributes may include at least one of one or more user-specific attributes, one or more session-specific attributes, and one or more historical attributes. The one or more user-specific attributes may be attributes describing the user. Examples of the one or more user-specific attributes may include, but are not limited to, a name of the user, a global location number (GLN) associated with the user, a phone number of the user, and an email identifier (ID) of the user. The session-specific attributes may be attributes describing a current context of user's interaction with the first client application. For instance, if the user session pertains to accessing of information about a product recall initiated by an organization, examples of the session-specific attributes may include, but are not limited to, a product recall ID, a phase ID defining a phase of the product recall, a current IP address through which the user session is requested to be established, or a current type of device through the user session is requested to be established. The historical attributes may be confidential attributes historically provided to the server by the user or another entity, such as a manufacturer of a product in case of the product recall, associated with the user session. Examples of the historical attributes may include, but are not limited to, a regulatory submission number that is a confidential information received from regulatory bodies, or a product delivery date on which a product corresponding to a product recall was delivered to the user. Thus, the set of attributes is a comprehensive, diverse, nuanced, and context-aware attribute set.

Once the set of attributes is obtained, the token generation engine 108 may derive an obfuscated claim set corresponding to the user session based on the set of attributes. In an example, the obfuscated claim set may be derived by encoding or encrypting the set of attributes into a format that is not easily interpretable by unauthorized parties. The obfuscated claim set may be unique to the user session. Thus, the obfuscated claim set may be a dynamic, session-specific claim set that is meaningless to an outside observer, such as a malicious attacker, and is hard to predict or reuse. The obfuscated claim set is to be provided to the first client application for being used for data access authentication during the user session. That is, once the obfuscated claim set are provided to the first client application, for every subsequent data access request during the user session, the first client application must share a claim set, that is same as the obfuscated claim set, with the server 102 for successful authentication by the server 102 to gain access to requested data.

For every application programming interface (API) call received from the first client application to access protected data during the user session, the authentication engine 110 may control access to the protected data based on a comparison of a claim set received within the API call with the obfuscated claim set. For example, if the claim set is determined to be same as the obfuscated claim set based on the comparison, the authentication engine 110 may grant access to the protected data. Further, if the claim set is determined to be different than the obfuscated claim set based on the comparison, the authentication engine 110 may restrict access to the protected data.

The obfuscated claim set uniquely derived for every user session based on a comprehensive set of attributes allows for a nuanced and context-aware approach to data access authentication and control. Thus, the present subject matter allows for fine-grain data access control preventing any malicious user from gaining unauthorized access to the protected data.

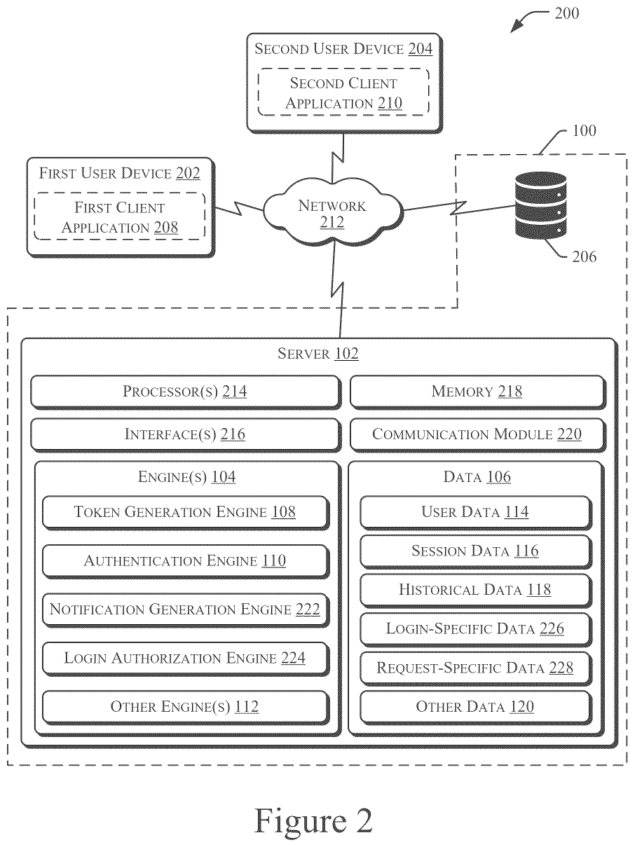

FIG. 2 illustrates a computing environment 200 implementing the server 102 for data access authentication, according to another example. In one example, the computing environment 200 may include the system 100, a first user device 202, and a second user device 204. The system 100 may include the server 102, as explained with reference to FIG. 1. The system 100 may further include a data repository 206 associated with the server 102. In an example, the data repository 206 may be managed by the server 102. The data repository 206 may store protected data that may be accessed by authorized users upon successful authentication based on data access authentication implemented by the server 102. In addition, or alternately, the data repository 206 may store confidential details required for authentication of users requesting access to the protected data managed by the server 102. The confidential details may include contact information of the authorized users or any other information, directly or indirectly, related to the authorized users or data access attempts by the authorized users. In an example, the first user device 202 and the second user device 204 may be any electronic device that allows an entity or a user to access, view, and interact with digital information or applications. In an example, the first user device 202 may be a device utilized by a user to access a first client application 208. The first client application 208 may serve as an interface through which users may access protected data residing on a database, say the data repository 206, managed by the server 102. The users may access the protected data based on data access authentication implemented by the server 102. The server 102 may be configured to control the first client application 208. In an example, the second user device 204 may be a device utilized by an entity to access a second client application 210. The second client application 210 may serve as an interface through which entities may request the server 102 to issue notifications for notifying the users to interact with the first client application 208 for accessing information associated with a current context of user's interaction with the first client application 208. Examples of the entity may include, but are not limited to, an organization to which the protected data belongs, an employee of the organization, and an external data management service managing the protected data for the organization. Although the data repository 206 has been shown external to the server 102, the data repository 206 may be internal to the server 102. The server 102 may be configured to control the second client application 210. Examples of the first user device 202 and the second user device 204 may include, but are not limited to, a smartphone, a laptop, a mobile phone, a computer, a desktop, a tablet computer, a wearable electronic device, a personal digital assistant (PDA), and any electronic device capable of transmitting or receiving data.

The server 102, the first user device 202, and the second user device 204 may be communicably coupled with each other over a communication network 212 and may exchange data and signals over the communication network 212. The communication network 212 may be a wireless network, a wired network, or a combination thereof. The communication network 212 may also be an individual network or a collection of many such individual networks, interconnected with each other and functioning as a single large network, e.g., the Internet or an intranet. Examples of such individual networks include local area network (LAN), wide area network (WAN), the internet, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN).

Depending on the technology, the communication network 212 may include various network entities, such as transceivers, gateways, and routers. In an example, the communication network 212 may include any communication network that uses any of the commonly used protocols, for example, Hypertext Transfer Protocol (HTTP), and Transmission Control Protocol/Internet Protocol (TCP/IP).

In one example, the server 102 may include processor(s) 214, interface(s) 216, memory 218, a communication module 220, the engine(s) 104, and the data 106. The server 102 may also include other components, such as display, input/output interfaces, operating systems, applications, and other software or hardware components (not shown in the figures).

The processor(s) 214 may be implemented as microprocessors, microcomputers, microcontrollers, digital signal processors, central processing units, state machines, logic circuitries, and/or other devices that manipulate signals based on operational instructions. The interface(s) 216 may allow the connection or coupling of the server 102 with one or more other devices, such as the first user device 202 and the second user device 204, through a wired (e.g., Local Area Network, i.e., LAN) connection or through a wireless connection (e.g., Bluetooth®, Wi-Fi). The interface(s) 216 may also enable intercommunication between different logical as well as hardware components of the server 102.

The memory 218 may be a computer-readable medium, examples of which include volatile memory (e.g., RAM), and/or non-volatile memory (e.g., Erasable Programmable read-only memory, i.e., EPROM, flash memory, etc.). The memory 218 may be an external memory or an internal memory, such as a flash drive, a compact disk drive, an external hard disk drive, or the like. The memory 218 may further include the data 106 and/or other data which may either be received, utilized, or generated during the operation of the server 102.

The communication module 220 may be a wireless communication module. Examples of the communication module 220 may include, but are not limited to, Global System for Mobile communication (GSM) modules, Code-division multiple access (CDMA) modules, Bluetooth modules, network interface cards (NIC), Wi-Fi modules, dial-up modules, Integrated Services Digital Network (ISDN) modules, Digital Subscriber Line (DSL) modules, and cable modules. In one example, the communication module 220 may also include one or more antennas to enable wireless transmission and reception of data and signals. The communication module 220 may allow the server 102 to transmit data and signals to one or more other devices, such as the first user device 202 and the second user device 204; and receive data and signals from the one or more other devices.

The engine(s) 104 may include the token generation engine 108, the authentication engine 110, and the other engine(s) 112, as explained with reference to FIG. 1. The engine(s) 104 may further include a notification generation engine 222 and a login authorization engine 224.

The data 106 may include the user data 114, the session data 116, the historical data 118, and the other data 120, as explained with reference to FIG. 1. In an example, the data 106 may further include login-specific data 226 and request-specific data 228. The login-specific data 226 may include data associated with a login request received from a user to initially login into the first client application 208. The request-specific data 228 may include data associated with a session establishment request received from the first client application 208, post the login request, to establish a user session with the first client application 208.

In operation, any entity, intending to notify one or more users about a specific event, may access the second client application 210 to issue a notification issuance request. The entity may use the second user device 204 for accessing the second client application 210 to notify the one or more users about the specific event. For instance, an organization that has taken a recall decision to recall a particular product manufactured by the organization, may intend to notify specific stakeholders about the recall decision. The specific stakeholders may include customers, partners, suppliers, and regulatory bodies that may be affected due to the recall of the particular product and thus should be notified about the recall decision. Thus, an entity associated with the organization may interact with the second client application 210, using the second user device 204, to issue the notification issuance request for notifying the specific stakeholders about the recall decision.

In an example, certain sensitive details about the specific event may only be accessed by the one or more users through the first client application 208. Thus, for accessing the certain sensitive details about the specific event, a user of the one or more users may need to establish a user session with the first client application 208. For instance, in case of the recall decision, details describing the particular product or a method for disposition of the particular product may be accessed by the one or more users by establishing a user session with the first client application 208. Therefore, while notifying about the specific event, the entity may also intend to notify the one or more users to interact with the first client application 208 for accessing the sensitive details. The entity may be hereinafter alternatively referred to as another entity or other entity associated with the user session. Once the notification issuance request is triggered by the other entity, the second client application 210 may transmit the notification issuance request to the server 102.

The notification generation engine 222 of the server 102 may receive the notification issuance request from the second client application 210. The notification issuance request may be initiated by the other entity associated with the user session to notify the one or more users to interact with the first client application 208 for accessing information associated with a current context of user's interaction with the first client application 208. For example, in case of the recall decision, the information associated with the current context of the user's interaction with the first client application 208 may be the details describing the particular product and the method for disposition of the particular product.

The notification generation engine 222 may obtain contact information corresponding to each of the one or more users. Examples of the contact information may include, but are not limited to, a phone number of the user and an email identified (ID) of the user. In an example, the contact information of the one or more users may be pre-stored in the memory 218 of the server 102 and may be obtained from the memory 218. For example, the contact information of the one or more users may be stored within the user data 114. In another example, the contact information of the one or more users may be obtained from an external database that manages contact information of a plurality of users including the one or more users. For example, the external database may be a customer database associated with the organization that manages contact information of consignees of products, including the particular product, manufactured by the organization. In yet another example, the contact information of a subset of all of the one or more users may be obtained from respective user directly.

The notification generation engine 222 may generate a notification for transmission to the one or more users. The notification may include an information access link associated with the current context. The information access link may be a link that, when selected by a user using the first user device 202, may direct the user to the first client application 208 by launching the first client application 208 on the first user device 202. That is, selection of the information access link within the notification launches the first client application 208 for initiating access to the information about the current context. The information may include protected data, such as the sensitive information, that may be accessed once the user session is established with the first client application 208.

The notification generation engine 222 may transmit the notification to each of the one or more users using the corresponding contact information. For instance, the notification may be transmitted as a text message to each user of the one or more users through a short message service (SMS) on the corresponding phone number of the user. In another instance, the notification may be transmitted to each user of the one or more users as an email on the corresponding email ID of the user. In yet another instance, the notification may be transmitted to some of the one or more users using the SMS and the remaining of the one or more users using the email. While the SMS and the email have been used as examples for transmitting the notification, the notification may also be transmitted to the user using other type of commonly available messaging services.

In an example, each of the one or more users may receive the notification through the SMS or the email on a corresponding first user device, say the first user device 202. Upon receiving the notification, a user may attempt to login into the first client application 208 using the information access link. Alternatively, the user may attempt to login into the first client application 208 without receiving the notification or the information access link. The user may attempt to login into the first client application 208 using the first user device 202.

The login authorization engine 224 of the server 102 may receive a login request from the user to login into the first client application 208. The login request may be triggered by the user using the first user device 202. In one example, the login request may be received from the first client application 208 when the user attempts to login into the first client application 208 by clicking on the information access link received within the notification. In another example, the login request may be received from the first client application 208 when the user directly attempts to login into the first client application 208 without the information access link.

Upon receiving the login request, the login authorization engine 224 may generate a temporary code corresponding to the login request. The temporary code may be used by the user to login into the first client application 208. In an example, the temporary code may be a one-time password (OTP). The login authorization engine 224 may transmit the temporary code to the user for enabling the user to login into the first client application 208 using the temporary code. The temporary code may be transmitted to the user, for example, through an SMS or an email, using the contact information corresponding to the user.

In addition to providing the temporary code to the user, the login authorization engine 224 may store login-specific data associated with the login request. In an example, the login-specific data may be stored in the memory 218 of the server 102. For example, the login-specific data may be stored within the login-specific data 226. The login-specific data may be used for authentication during establishment of the user session with the first client application 208. That is, the login-specific data may be used for authentication when the user attempts to establish the user session by attempting to login into the first client application 208 after receiving the temporary code from the server 102.

The login-specific data may include at least one of the temporary code, the contact information corresponding to the user, at least one session-specific attribute describing the current context of interaction with the first client application 208, and at least one login attribute describing the login request. For example, if the current context of interaction with the first client application 208 is to access protected data related to a product recall initiated by an organization, the at least one session-specific attribute may include a product ID uniquely defining the product recall and a phase ID defining a phase of the product recall. Examples of the at least one login attribute may include, but are not limited to, a global location number (GLN) associated with a location from which the user triggered the login request and a particular IP address through which the user triggered the login request.

The user intending to login into the first client application 208 for accessing the protected date may trigger a session establishment request using the first user device 202. The session establishment request may be a request for establishing the user session with the first client application 208. In an example, for triggering the session establishment request, the user may enter an access code into a login page of the first client application 208. Once the access code is entered by the user, the first client application 208 may transmit the session establishment request to the server 102.

The login authorization engine 224 of the server 102 may receive the session establishment request from the user. For example, the session establishment request is received when the user enters the access code into the login page of the first client application 208. Upon receiving the session establishment request, the login authorization engine 224 may initiate an authentication process to ascertain whether the session establishment request is authentic. The authentication process is initiated before allowing the user to login into the first client application 208.

In an example, during the authentication process, the login authorization engine 224 may obtain request-specific data associated with the session establishment request. The request-specific data may include at least one of the access code, contact information associated with the session establishment request, a session-specific attribute associated with the session establishment request, and a request attribute describing the session establishment request. The contact information associated with the session establishment request may be a particular contact information using which the session establishment request is triggered. The session-specific attribute may be an attribute describing a specific context of interaction with the first client application 208 for which the user triggered the session establishment request. In one example, the session-specific attribute may include a specific product ID uniquely defining a specific product recall if the specific context of interaction with the first client application 208 is to access protected data related to the specific product recall initiated by an organization. In addition, or alternately, the session-specific attribute may include a specific phase ID defining a phase of the specific product recall. Examples of the request attribute may include, but are not limited to, a specific global location number (GLN) associated with a particular location from which the user triggered the session establishment request and a specific IP address through which the user triggered the session establishment request. In an example, the request-specific data may be stored within the request-specific data 228.

Once the request-specific data is obtained, the login authorization engine 224 may analyze the request-specific data and the login-specific data to ascertain whether the session establishment request is authentic. In an example, the session establishment request may be ascertained to be authentic when the request-specific data is similar to the login-specific data. In an example, the session establishment request may be ascertained to be unauthentic when the request-specific data is different from the login-specific data. For example, if the temporary code is determined to be different than the access code, the session establishment request may be ascertained as a malicious attempt of logging into the first client application 208. In another example, if the temporary code is determined to be same as the access code, but the GLN associated with the login request is found to be substantially different than the specific GLN associated with the session establishment request, the session establishment request may be ascertained as a malicious attempt of logging into the first client application 208.

Upon ascertaining the session establishment request to be authentic, the token generation engine 108 of the server 102 may obtain a set of attributes corresponding to the user session requested to be established by the user with the first client application 208. In one example, the set of attributes may be pre-stored in the memory 218 of the server and may be obtained from the memory 218. For instance, the set of attributes may be selected from data stored within the user data 114, session data 116, and the historical data 118. In another example, the set of attributes may be obtained from external sources, such as the user, the other entity associated with the user session, or an external database within which confidential information pertaining to the user or the user session may be stored.

The set of attributes may include at least one of one or more user-specific attributes, one or more session-specific attributes, and one or more historical attributes. The one or more user-specific attributes may be attributes describing the user. Examples of the one or more user-specific attributes may include, but are not limited to, a name of the user, a global location number (GLN) associated with the user, a phone number of the user, and an email identifier (ID) of the user. The session-specific attributes may be attributes describing a current context of user's interaction with the first client application. For instance, if the user session pertains to accessing of information about a product recall initiated by an organization, examples of the session-specific attributes may include, but are not limited to, a product recall ID, a phase ID defining a phase of the product recall, a current IP address through which the user session is requested to be established, or a current type of device through the user session is requested to be established. The historical attributes may be confidential attributes historically provided to the server by the user or another entity, such as a manufacturer of a product in case of the product recall, associated with the user session. Examples of the historical attributes may include, but are not limited to, a regulatory submission number that is a confidential information received from regulatory bodies, or a product delivery date on which a product corresponding to a product recall was delivered to the user. Thus, the set of attributes is a comprehensive, diverse, nuanced, and context-aware attribute set.

Once the set of attributes is obtained, the token generation engine 108 may derive an obfuscated claim set corresponding to the user session based on the set of attributes. In an example, the obfuscated claim set may be derived by encoding or encrypting the set of attributes into a format that is not easily interpretable by unauthorized parties. The obfuscated claim set may be unique to the user session. Thus, the obfuscated claim set may be a dynamic, session-specific claim set that is meaningless to an outside observer, such as a malicious attacker, and is hard to predict or reuse. The obfuscated claim set is to be provided to the first client application 208 for being used for data access authentication during the user session. That is, once the obfuscated claim set are provided to the first client application, for every subsequent data access request during the user session, the first client application 208 must share a claim set, that is same as the obfuscated claim set, with the server 102 for successful authentication by the server 102 to gain access to requested data.

For providing the obfuscated claim set to the first client application 208, the token generation engine 108 may generate a session-specific token corresponding to the user session. The session-specific token may incorporate the obfuscated claim set. In an example, the session-specific token may be a JavaScript Object Notation (JSON) Web Token (JWT). The token generation engine 108 may encode the session-specific token to generate an encoded session-specific token. The session-specific token may be encoded using standard encoding techniques to ensure safe transmission of the session-specific token to the first client application 208. For ensuring secure transmission of the session-specific token, the token generation engine 108 may further embed the encoded session-specific token within a session cookie for transmission to the first client application 208. Example of the session cookie may include, but is not limited to, a Hypertext Transfer Protocol Secure (Https) cookie. The session cookie may then be transmitted to the first client application 208 to securely provide the obfuscated claim set to the first client application 208. The session-specific token within the session cookie may be utilized by the first client application 208 for generating call-specific tokens for data access authentication during the user session.

For every application programming interface (API) call received at the server 102 from the first client application 208 to access protected data during the user session, the authentication engine 110 of the server 102 may control access to the protected data based on a comparison of a claim set received within the API call with the obfuscated claim set. For example, if the claim set is determined to be same as the obfuscated claim set based on the comparison, the authentication engine 110 may grant access to the protected data. Further, if the claim set is determined to be different than the obfuscated claim set based on the comparison, the authentication engine 110 may restrict access to the protected data.

In an example, for accessing specific protected data, the user may trigger a particular API call to the server 102 using the first client application 208 on the first user device 202. The particular API call may pertain to accessing of the specific protected data during the user session. The authentication engine 110 may receive the particular API call. The particular API call may include a call-specific cookie including an encoded call-specific token. Example of the call-specific cookie may include, but is not limited to, a Hypertext Transfer Protocol Secure (Https) cookie. In an example, the encoded call-specific token may be an encoded form of a JavaScript Object Notation (JSON) Web Token (JWT).

Upon receiving the particular API call, the authentication engine 110 may extract the encoded call-specific token from the call-specific cookie. Then, the authentication engine 110 may decode the encoded call-specific token to derive a particular claim set included in the encoded call-specific token. For decoding the encoded call-specific token, a specific decoding technique, that corresponds to an encoding technique used to encode the call-specific token, may be utilized. The particular claim set may contain specific claims to be used for authentication of the particular API call.

The authentication engine 110 may compare the particular claim set with the obfuscated claim set to ascertain whether the particular claim set is valid. The obfuscated claim set may be stored in the memory 218 and may be obtained from the memory 218 for comparison with the particular claim set for data access authentication. For example, the particular claim set may be ascertained to be valid if the particular claim set is determined to be same as the obfuscated claim set. The particular claim set may be ascertained to be invalid if the particular claim set is determined to be different than the obfuscated claim set.

For comparing the particular claim set with the obfuscated claim set, first claims may be extracted from the obfuscated claim set and second claims may be extracted from the particular claim set. Corresponding claims of the first and second claims may be compared with each other to check whether corresponding claim types and corresponding claim values of the corresponding claims are same or different. For example, the obfuscated claim set may include three claims, where a first claim may pertain to a first claim type “user name” having a first claim value “user A”, a second claim may pertain to a second claim type “consignment delivery date” having a second claim value “date A”, and a third claim may pertain to a third claim type “recall ID” having a third claim value “ABCDEF”. Thus, the particular claim set may be ascertained to be valid when the second claims have three claims with the first, second, and third claim types having the first, second, and third claim values same as the three claims extracted from the obfuscated claim set. If any of the corresponding claims of the first and second claims is found to be different with respect to the claim type or the claim value, the particular claim set may be ascertained to be invalid.

Upon ascertaining the particular claim set to be valid, the authentication engine 110 may grant access to the specific protected data. For granting access to the specific protected data, the server 102 may send a grant signal to the first client application 208 to allow the user to view the protected data through the first user device 202. Once the first client application 208 receives the grant signal from the server 102, the first client application 208 may present the protected data on a display of the first user device 202.

Upon ascertaining the particular claim set to be invalid, the authentication engine 110 may restrict access to the specific protected data. For restricting access to the specific protected data, the server 102 may send a restrict signal to the first client application 208 to prevent display of the protected data on the first user device 202. Once the first client application 208 receives the restrict grant signal from the server 102, the first client application 208 may present an indication, depicting that the protected data cannot be accessed, to the user on the display of the first user device 202.

The present subject matter incorporates various attributes, including user-specific attributes, session-specific attributes, and confidential historical attributes, into the claim set which may not make any sense to the attackers, thereby allowing for highly granular and adaptive data access control. The present subject matter thus provides a dynamic approach that enables the server 102 to make real-time decisions about data access authorization quickly and efficiently.

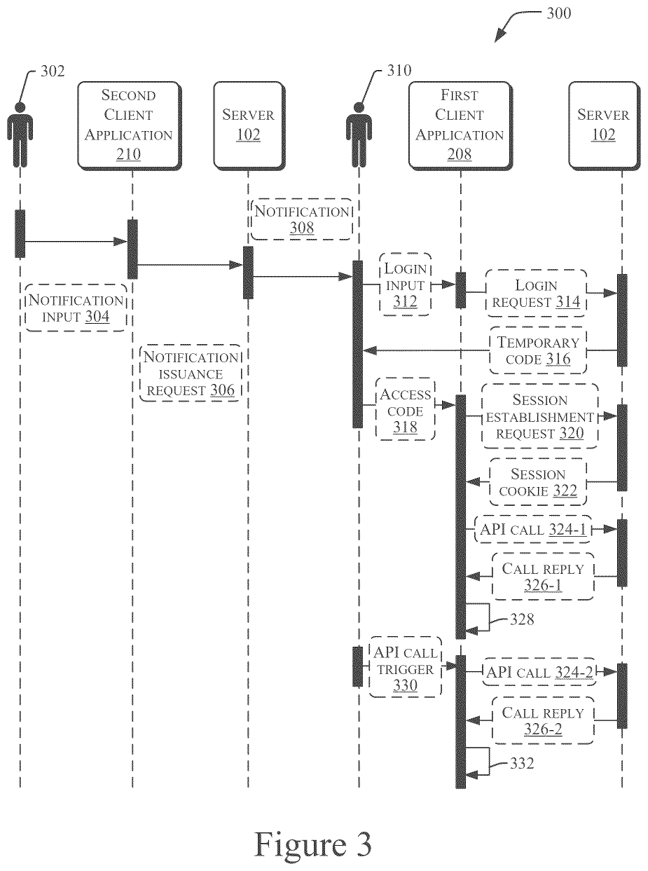

FIG. 3 illustrates an exemplary data flow 300 representing communication between various computational entities of the computing environment 200 for data access authentication, according to an example. The order in which the data flow 300 is described is not intended to be construed as a limitation, and some of the described components of the data flow 300 may be combined in a different order to implement a data flow according to the data flow 300, or an alternative data flow.

According to the data flow 300, an entity 302, intending to notify one or more users about a specific event, may access the second client application 210 and may provide a notification input 304 to the second client application 210. The notification input 304 may be any type of input that triggers the second client application 210 to initiate a process of sending a notification about the specific event to the one or more users. For instance, the notification input 304 may include a touch input selecting a “send notification” icon on a user interface of the second client application 210. The entity 302 may use any electronic device, say the second user device 204, for accessing the second client application 210 and providing the notification input 304. Example of the specific event may include, but is not limited to, a recall decision taken by an organization to recall a particular product manufactured by the organization. In one example, the entity 302 may be an employee of an organization hosting the server 102 and intending to notify specific stakeholders, such as customers, partners, suppliers, and regulatory bodies, about various events, such as recall decision, as discussed in previous Figures.

Upon receiving the notification input 304, the second client application 210 may issue a notification issuance request 306 to the server 102. In an example, certain sensitive details about the specific event may only be accessed by the one or more users through the first client application 208. Thus, the second client application 210 may generate an information access link corresponding to the first client application 208. The information access link may be a link that, when selected by a user using a particular electronic device, say the first user device 202, may direct the user to the first client application 208 by launching the first client application 208 on the particular electronic device. In an example, the information access link may be a non-expiring Uniform Resource Locator (URL) or a short-lived URL.

In addition, or alternately, the second client application 210 may generate a notification message that is to be shared with the one or more users. For example, if the specific event is the recall decision, the notification message may read as “Company XYZ has decided to recall Product ABC. For more details, you may login into the first client application using the information access link provided below: <<information access link>>”. The notification issuance request 306 may include the information access link and the notification message. Thus, the notification issuance request 306 may be initiated to notify the one or more users to interact with the first client application 208 for accessing information about the specific event.

Upon receiving the notification issuance request 306, the server 102 may obtain contact information corresponding to each of the one or more users. Examples of the contact information may include, but are not limited to, a phone number of the user and an email identified (ID) of the user. Further, the server 102 may generate a notification 308 including the information access link. In addition, or alternately, the notification 308 may also include the notification message. The server 102 may transmit the notification 308 to the one or more users, including a user 310, using the contact information.

The one or more users may view the notification 308 using any electronic device, say the first user device 202. Any of the one or more users, intending to login into the first client application 208, may provide a login input to the first client application 208. For instance, the user 310 may provide a login input 312 to the first client application 208. The login input 312 may be provided by the user 310 using any electronic device, say the first user device 202. The login input 312 may be any type of input that triggers the first client application 208 to initiate a process of logging into the first client application 208. The user 310 may provide the login input 312 upon receiving the notification 308. For instance, the login input 312 may include a touch input, clicking the information access link in the notification 308. Alternatively, the user 310 may provide the login input 312 without receiving the notification 308 or the information access link. For instance, the login input 312 may include one or more inputs for opening a software application, pre-installed in the first user device 202, corresponding to the first client application 208 or for opening an official website corresponding to the first client application 208.

In an example, the user 310 may attempt to login into the first client application 208 by proving the login input 312 to update personal contact information corresponding to the user 310. In addition, or alternately, if the specific event is the recall decision, the user 310 may attempt to login into the first client application 208 to access details describing the particular product that has been recalled, and access details about a method for disposition of the particular product.

Upon receiving the login input 312, the first client application 208 may redirect the user 310 to a login page displayed on the first user device 202. The login page may be an interactive interface asking the user 310 to enter a code for logging into the first client application 208. Simultaneously, the first client application 208 may send a login request 314 to the server 102. The login request 314 may indicate that the user 310 has attempted to login into the first client application 208.

Upon receiving the login request 314, the server 102 may generate a temporary code 316 corresponding to the login request 314. In an example, the temporary code 316 may be a one-time password (OTP). The server 102 may transmit the temporary code 316 to the user 310 using the contact information of the user 310, for enabling the user 310 to use the temporary code 316 for logging into the first client application 208. In addition to providing the temporary code 316 to the user 310, the server 102 may store login-specific data associated with the login request 314 for authentication at a later time. The login-specific data may include at least one of the temporary code, the contact information corresponding to the user 310, at least one session-specific attribute describing a current context of interaction with the first client application 208, and at least one login attribute describing the login request.

Once the user 310 receives the temporary code 316, the user 310 may enter an access code 318 into the login page displayed on the first user device 202. The access code 318 may either be same as the temporary code 316 or may be different than the temporary code 316. For example, the access code 318 may be same as the temporary code 316 if the access code 318 is correctly entered by an authorized user who has received the temporary code 316 or if the access code 318 is correctly guessed and entered by a malicious user who has not received the temporary code 316. Further, the access code 318 may be different than the temporary code 316 if the access code 318 is incorrectly entered by the authorized user by mistake or if the access code 318 is incorrectly entered by the malicious user.

Upon receiving the access code 318, the first client application 208 may send a session establishment request 320 to the server 102. The session establishment request 320 may be a request for establishing a user session with the first client application 208. The user session may be established to access information associated with the current context of interaction with the first client application 208, for example, for accessing details about the specific event.

Upon receiving the session establishment request 320, the server 102 may initiate an authentication process to ascertain whether the session establishment request 320 is authentic. During the authentication process, the server 102 may analyze request-specific data and the login-specific data to ascertain whether the session establishment request 320 is authentic. The request-specific data may include at least one of the access code 318, contact information associated with the session establishment request 320, a session-specific attribute associated with the session establishment request 320, and a request attribute describing the session establishment request 320. In an example, the session establishment request 320 may be ascertained to be authentic when the request-specific data is similar to the login-specific data. In an example, the session establishment request 320 may be ascertained to be unauthentic when the request-specific data is different from the login-specific data.

Upon ascertaining the session establishment request 320 to be unauthentic, the server 102 may send an authentication failure signal to the first client application 208. The authentication failure signal may indicate that the user 310 is not allowed to establish the user session with the first client application 208. Upon ascertaining the session establishment request 320 to be authentic, the server 102 may generate and transmit a session cookie 322, corresponding to the user session, to the first client application 208. The session cookie 322 may include an encoded session-specific token having an obfuscated claim set. In an example, the session-specific token may be a JWT. The obfuscated claim set may be a dynamic, session-specific claim set that is meaningless to an outside observer, such as a malicious attacker, and is hard to predict or reuse.

Once the session cookie 322 is received at the first client application 208, the first client application 208 may transmit a first API call 324-1 to the server 102. The first API call 324-1 may be a call to the server 102 to authenticate the first client application 208 to transition user interface displayed on the first user device 202 from the login page to a logged-in page of the first client application 208. The first API call 324-1 may include a call-specific cookie. The call-specific cookie may include an encoded call-specific token having a particular claim set. In an example, the encoded call-specific token may be an encoded form of a JWT.

Upon receiving the first API call 324-1, the server 102 may compare the particular claim set with the obfuscated claim set to ascertain whether the particular claim set is valid. The server 102 may transmit a first call reply 326-1 to the first client application 208 based on whether the particular claim set is valid or invalid. For example, when the particular claim set is ascertained to be valid based on a determination that the particular claim set is same as the obfuscated claim set, the first call reply 326-1 may include a session success indicator indicating that the first API call 324-1 is received from an authorized user. When the particular claim set is ascertained to be invalid based on a determination that the particular claim set is different than the obfuscated claim set, the first call reply 326-1 may include a session failure indicator indicating that the first API call 324-1 is received from a malicious user.

Upon receiving the first call reply 326-1, at step 328, the first client application 208 may transition user interface displayed on the first user device 202 based on the first call reply 326-1. For example, if the first call reply 326-1 includes the session success indicator, at step 328, the first client application 208 may transition the user interface displayed on the first user device 202 from the login page to a logged-in page of the first client application 208. However, if the first call reply 326-1 includes the session failure indicator, at step 328, the first client application 208 may transition the user interface displayed on the first user device 202 from the login page to an error page of the first client application 208 without logging into the first client application 208.

For every subsequent API call received at the server 102 from the first client application 208 to access protected data during the user session, the server 102 may control access to the protected data based on a comparison of a claim set received within the subsequent API call with the obfuscated claim set. Every subsequent API call may be triggered by the user 310 by providing an API call trigger 330 using the first user device 202. The API call trigger 330 may be any input provided by the user 310 that triggers the first client application 208 to send an API call to the server 102 for accessing protected data. For example, the API call trigger 330 may include a touch input selecting a “show contact information” icon displayed within the logged-in page.

Upon receiving the API call trigger 330, the first client application 208 may transmit an API call to the server 102. For instance, the first client application 208 may transmit a second API call 324-2. The second API call 324-2 may be a call to the server 102 to authenticate the first client application 208 to display protected data, requested to be displayed by the user 310 through the API call trigger 330, on the first user device 202. The second API call 324-2 may include a call-specific cookie including an encoded call-specific token having a specific claim set.

Upon receiving the second API call 324-2, the server 102 may compare the specific claim set with the obfuscated claim set to ascertain whether the specific claim set is valid. The server 102 may transmit a second call reply 326-2 to the first client application 208 based on whether the specific claim set is valid or invalid.

Upon receiving the second call reply 326-2, at step 332, the first client application 208 may transition user interface displayed on the first user device 202 based on the second call reply 326-2. For example, if the second call reply 326-2 includes the session success indicator, at step 332, the first client application 208 may display the protected data on the user interface displayed on the first user device 202. However, if the second call reply 326-2 includes the session failure indicator, at step 332, the first client application 208 may display an error message, indicating that the protected data cannot be displayed, on the user interface displayed on the first user device 202. The present subject matter thus provides a dynamic approach that enables the server 102 to make real-time decisions about data access authorization quickly and efficiently.

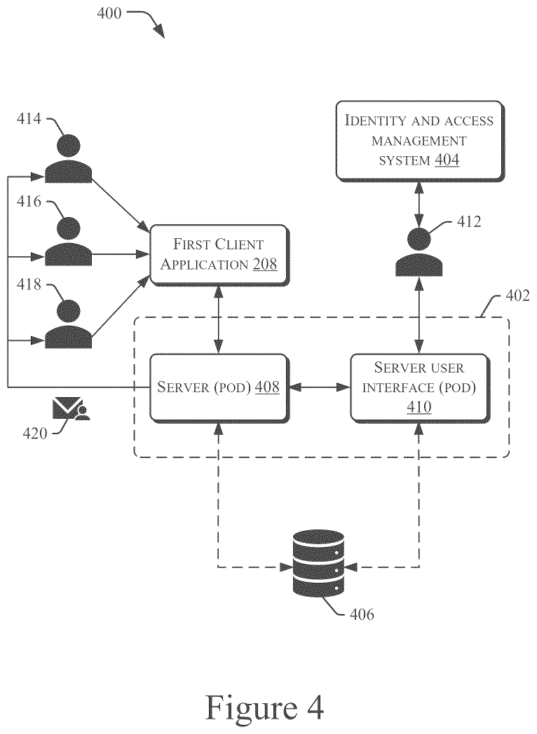

FIG. 4 illustrates a computing environment 400 implementing a private cluster 402 for data access authentication, according to an example. In one example, the computing environment 200 may include the private cluster 402, the first client application 208, an identity and access management system 404, and a database 406. The private cluster 402 may be a container orchestration platform for scheduling and automating deployment and management of containerized applications. In an example, the private cluster 402 may be a software component of the server 102 and the containerized applications may include the functions implemented by the server 102. In an example, the private cluster 402 may be a private Elastic Kubernetes Service (EKS) platform.

The private cluster 402 may include a server (pod) 408 and a server user interface (UI) (pod) 410. The server (pod) 408 may be configured to implement the functions of the server 102. The server UI pod 410 may be configured to provide user interfaces corresponding to the second client application 210 based on instructions from the server (pod) 408. The private cluster 402 may represent a backend infrastructure, while the first client application 208, controlled by the server (pod) 408, and the second client application 210, controlled by the server UI (pod) 410 and the server (pod) 408, may represent a frontend interface.

The identity and access management system 404 may be configured to manage the identities of various entities that are authorized to interact with the second client application 210. Further, the identity and access management system 404 may be configured to authenticate any entity that intends to interact with the second client application 210 based on the managed identities.

The database 406, such as the data repository 206, may store protected data that may be accessed by authorized users upon successful authentication based on data access authentication implemented by the server 102. In addition, or alternately, the database 406 may store confidential details required for authentication of users requesting access to the protected data managed by the server 102. The confidential details may include contact information of the authorized users or any other information, directly or indirectly, related to the authorized users or data access attempts by the authorized users. In one example, the database 406 may be a relational database.

In operation, an entity 412 may need to be authenticated by the identity and access management system 404 before the entity 412 is allowed to interact with the second client application 210. Once identity of the entity 412 is authenticated by the identity and access management system 404, the second client application 210 may display interfaces controlled by the server UI (pod) 410 which is in turn controlled by the server (pod) 408. The entity 412 may interact with the second client application 210 with an intention to notify one or more users 414, 416, and 418, about a specific event. Details, including the protected data, about the specific event may be accessed by the one or more users 414, 416, and 418 using the first client application 208. Examples of the entity 412 may include, but are not limited to, an organization to which the protected data belongs, an employee of the organization, and an external data management service managing the protected data for the organization.

When the entity 412 requests the server 102 to notify the one or more users 414, 416, and 418, about a specific event using the second client application 210, the server (pod) 408 may obtain contact information corresponding to each of the one or more users 414, 416, and 418 from the database 406. The server (pod) 408 may generate and transmit a notification 420 to the one or more users 414, 416, and 418 using the corresponding contact information. The notification 420 may include an information access link. The information access link may be a link that, when selected by any user, say user 414 of the one or more users 414, 416, and 418, may direct the user 414 to the first client application 208 by launching the first client application 208. Any of the one or more users 414, 416, and 418 may interact with the first client application 208 to access the protected data based on data access authentication implemented by the server (pod) 408 associated with the server 102, as explained in detail with reference to FIGS. 1 to 3 above. The present subject matter thus provides a dynamic approach that enables the server (pod) 408 to make real-time decisions about data access authorization quickly and efficiently.

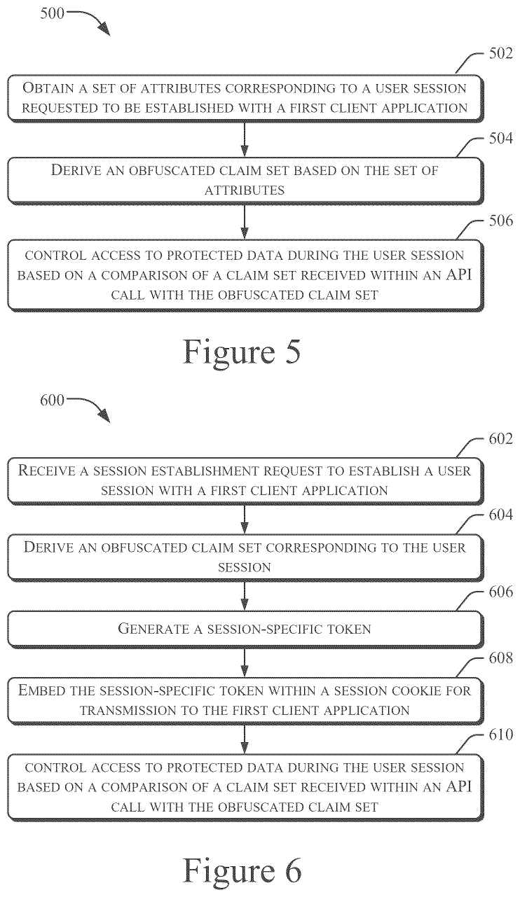

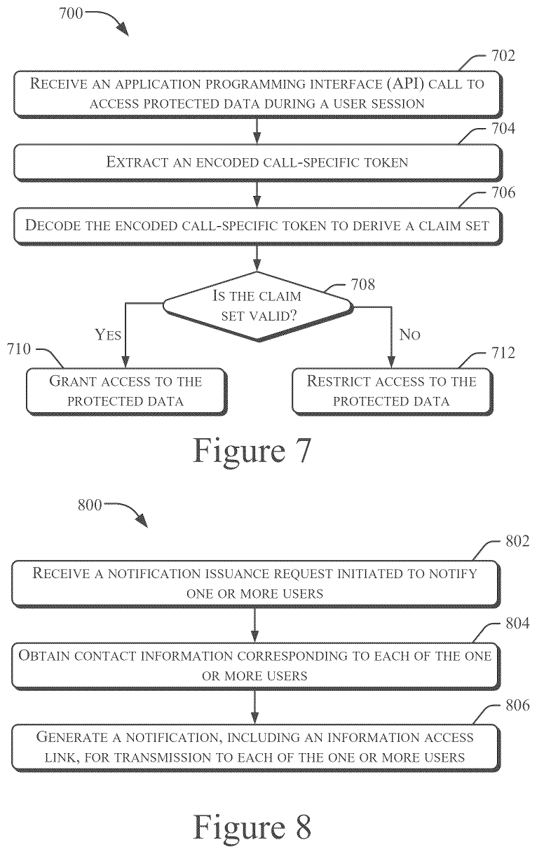

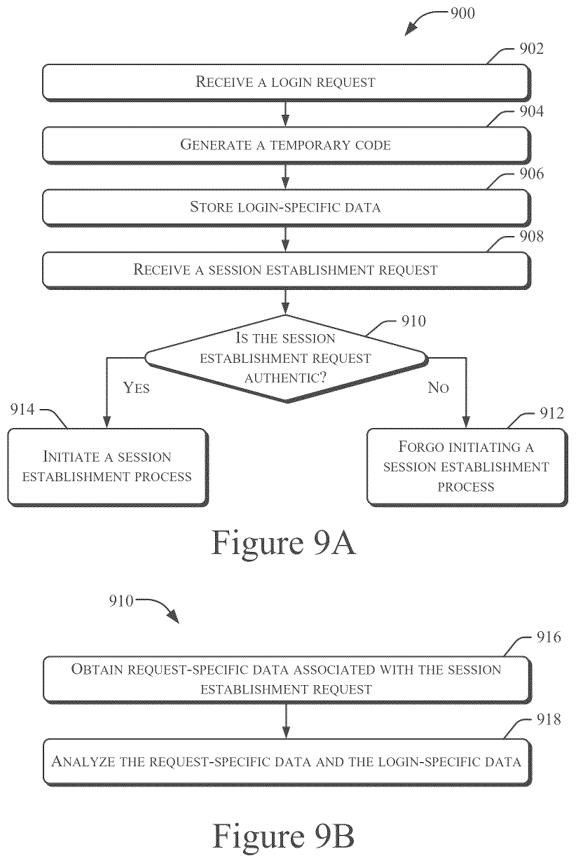

FIG. 5, FIG. 6, FIG. 7, FIG. 8, FIG. 9A, and FIG. 9B, illustrate example methods 500, 600, 700, 800, 900, and 910, respectively, for notifying one or more users to access protected data, authenticating a session establishment request initiated for establishing a user session to access the protected data, for data access authentication. The order in which the methods are described is not intended to be construed as a limitation, and any number of the described method blocks may be combined in any order to implement the methods, or an alternative method. Further, the methods 500, 600, 700, 800, 900, and 910 may be implemented by processing resource or computing device(s) through any suitable hardware, non-transitory machine-readable instructions, or combination thereof.

It may also be understood that methods 500, 600, 700, 800, 900, and 910 may be performed by programmed computing devices, such as the server 102 of the system 100, as depicted in FIG. 1, FIG. 2, and FIG. 3. Furthermore, the methods 500, 600, 700, 800, 900, and 910 may be executed based on instructions stored in a non-transitory computer-readable medium, as will be readily understood. The non-transitory computer-readable medium may include, for example, digital memories, magnetic storage media, such as one or more magnetic disks and magnetic tapes, hard drives, or optically readable digital data storage media. While the methods 500, 600, 700, 800, 900, and 910 are described below with reference to the server 102 of the system 100 as described above; other suitable systems for the execution of these methods may also be utilized. Additionally, implementation of the methods 500, 600, 700, 800, 900, and 910 is not limited to such examples.

FIG. 5 illustrates the method 500 for data access authentication, according to an example.

For enabling data access authentication, at block 502, a set of attributes corresponding to a user session requested to be established by a user with a first client application, say the first client application 208, may be obtained. The first client application may be controlled by a server, say the server 102 of the system 100. In one example, the set of attributes may be obtained by querying an internal database of the server. In another example, the set of attributes may be obtained from external sources, such as the user, another entity associated with the user session, or an external database within which confidential information pertaining to the user or the user session may be stored.

The set of attributes may include at least one of one or more user-specific attributes, one or more session-specific attributes, and one or more historical attributes. The one or more user-specific attributes may be attributes describing the user. Examples of the one or more user-specific attributes may include, but are not limited to, a name of the user, a global location number (GLN) associated with the user, a phone number of the user, and an email identifier (ID) of the user. The session-specific attributes may be attributes describing a current context of user's interaction with the first client application. For instance, if the user session pertains to accessing of information about a product recall initiated by an organization, examples of the session-specific attributes may include, but are not limited to, a product recall ID, a phase ID defining a phase of the product recall, a current IP address through which the user session is requested to be established, or a current type of device through the user session is requested to be established. The historical attributes may be confidential attributes historically provided to the server by the user or another entity, such as a manufacturer of a product in case of the product recall, associated with the user session. Examples of the historical attributes may include, but are not limited to, a regulatory submission number that is a confidential information received from regulatory bodies, or a product delivery date on which a product corresponding to a product recall was delivered to the user. Thus, the set of attributes is a comprehensive, diverse, nuanced, and context-aware attribute set.

Once the set of attributes is obtained, at block 504, an obfuscated claim set corresponding to the user session may be derived based on the set of attributes. In an example, the obfuscated claim set may be derived by encoding or encrypting the set of attributes into a format that is not easily interpretable by unauthorized parties. The obfuscated claim set may be unique to the user session. Thus, the obfuscated claim set may be a dynamic, session-specific claim set that is meaningless to an outside observer, such as a malicious attacker, and is hard to predict or reuse. The obfuscated claim set is to be provided to the first client application for being used for data access authentication during the user session. That is, once the obfuscated claim set are provided to the first client application, for every subsequent data access request during the user session, the first client application must share a claim set, that is same as the obfuscated claim set, with the server for successful authentication by the server to gain access to requested data.

At block 506, for every application programming interface (API) call received from the first client application to access protected data during the user session, access to the protected data may be controlled based on a comparison of a claim set received within the API call with the obfuscated claim set. For example, if the claim set is determined to be same as the obfuscated claim set based on the comparison, access to the protected data may be granted. Further, if the claim set is determined to be different than the obfuscated claim set based on the comparison, access to the protected data may be restricted.

The obfuscated claim set uniquely derived for every user session based on a comprehensive set of attributes allows for a nuanced and context-aware approach to data access authentication and control. Thus, the present subject matter allows for fine-grain data access control preventing any malicious user from gaining unauthorized access to the protected data.

FIG. 6 illustrates the method 600 for data access authentication, according to another example.

At block 602, a session establishment request may be received at a server, say the server 102 of the system 100, from a user. The session establishment request may be a request for establishing a user session with a first client application. User sessions established with the first client application may be controlled by the server. In an example, the session establishment request may be received when the user enters an access code into a login page of the first client application for authentication and establishment of the user session.

At block 604, an obfuscated claim set corresponding to the user session may be derived. The obfuscated claim set may be derived based on a set of attributes. The set of attributes may include at least one of one or more user-specific attributes, one or more session-specific attributes, and one or more historical attributes. The one or more user-specific attributes may be attributes describing the user. Examples of the one or more user-specific attributes may include, but are not limited to, a name of the user, a global location number (GLN) associated with the user, a phone number of the user, and an email identifier (ID) of the user. The session-specific attributes may be attributes describing a current context of user's interaction with the first client application. For instance, if the user session pertains to accessing of information about a product recall initiated by an organization, examples of the session-specific attributes may include, but are not limited to, a product recall ID, a phase ID defining a phase of the product recall, a current IP address through which the user session is requested to be established, or a current type of device through the user session is requested to be established. The historical attributes may be confidential attributes historically provided to the server by the user or another entity, such as a manufacturer of a product in case of the product recall, associated with the user session. Examples of the historical attributes may include, but are not limited to, a regulatory submission number that is a confidential information received from regulatory bodies, or a product delivery date on which a product corresponding to a product recall was delivered to the user. Thus, the set of attributes is a comprehensive, diverse, nuanced, and context-aware attribute set.

In an example, the obfuscated claim set may be derived by encoding or encrypting the set of attributes into a format that is not easily interpretable by unauthorized parties. The obfuscated claim set may be unique to the user session. Thus, the obfuscated claim set may be a dynamic, session-specific claim set that is meaningless to an outside observer, such as a malicious attacker, and is hard to predict or reuse. The obfuscated claim set is to be provided to the first client application for being used for data access authentication during the user session. That is, once the obfuscated claim set are provided to the first client application, for every subsequent data access request during the user session, the first client application must share a claim set, that is same as the obfuscated claim set, with the server for successful authentication by the server to gain access to requested data.

For providing the obfuscated claim set to the first client application, at block 606, a session-specific token may be generated corresponding to the user session. The session-specific token may incorporate the obfuscated claim set. In an example, the session-specific token may be a JavaScript Object Notation (JSON) Web Token (JWT). In an example, the session-specific token may be encoded to generate an encoded session-specific token. The session-specific token may be encoded using standard encoding techniques to ensure safe transmission of the session-specific token to the first client application.

For ensuring secure transmission of the session-specific token, at block 608, the session-specific token may be embedded within a session cookie for transmission to the first client application. In an example, embedding the session-specific token within the session cookie may comprise embedding the encoded session-specific token within the session cookie. Example of the session cookie may include, but is not limited to, a Hypertext Transfer Protocol Secure (Https) cookie. The session cookie may be transmitted to the first client application to securely provide the obfuscated claim set to the first client application. The session-specific token within the session cookie may be utilized by the first client application for generating call-specific tokens for data access authentication during the user session.

At block 610, for every application programming interface (API) call received from the first client application to access protected data during the user session, access to the protected data may be controlled based on a comparison of a claim set included in a call-specific token received within the API call with the obfuscated claim set. For example, if the claim set is determined to be same as the obfuscated claim set based on the comparison, access to the protected data may be granted. Further, if the claim set is determined to be different than the obfuscated claim set based on the comparison, access to the protected data may be restricted. Thus, the present subject matter allows for fine-grain data access control preventing any malicious user from gaining unauthorized access to the protected data.

FIG. 7 illustrates the method 700 for data access authentication, according to yet another example.

At block 702, an application programming interface (API) call may be received by a server, say the server 102 of the system 100. The API call may pertain to accessing of protected data during a user session established by a user with a first client application, say the first client application 208. User sessions established with the first client application may be controlled by the server. In an example, the particular API call may include a call-specific cookie including an encoded call-specific token. Example of the call-specific cookie may include, but is not limited to, a Hypertext Transfer Protocol Secure (Https) cookie. In an example, the encoded call-specific token may be an encoded form of a JavaScript Object Notation (JSON) Web Token (JWT).

At block 704, the encoded call-specific token may be extracted from the call-specific cookie. In an example, the encoded call-specific token may be extracted from the call-specific cookie using commonly known token extraction techniques.

At block 706, the encoded call-specific token may be decoded to derive a claim set included in the encoded call-specific token. The claim set may contain specific claims to be used for authentication of the API call. For decoding the encoded call-specific token, a specific decoding technique, that corresponds to an encoding technique used to encode the call-specific token, may be utilized. In an example, the specific decoding technique may be any commonly known token deserialization technique.

At block 708, it is ascertained whether the claim set is valid. For ascertaining whether the claim set is valid, the claim set may be compared with the obfuscated claim set. The obfuscated claim set may be stored in a memory, say the memory 218 of the server 102, and may be obtained from the memory for comparison with the claim set for data access authentication. For example, the claim set may be ascertained to be valid if the claim set is determined to be same as the obfuscated claim set. The claim set may be ascertained to be invalid if the claim set is determined to be different than the obfuscated claim set.

For comparing the claim set with the obfuscated claim set, first claims may be extracted from the obfuscated claim set and second claims, i.e., the specific claims, may be extracted from the claim set. Corresponding claims of the first and second claims may be compared with each other to check whether corresponding claim types and corresponding claim values of the corresponding claims are same or different. For example, the obfuscated claim set may include three claims, where a first claim may pertain to a first claim type “user name” having a first claim value “user A”, a second claim may pertain to a second claim type “consignment delivery date” having a second claim value “date A”, and a third claim may pertain to a third claim type “recall ID” having a third claim value “ABCDEF”. Thus, the claim set may be ascertained to be valid when the second claims have three claims with the first, second, and third claim types having the first, second, and third claim values same as the three claims extracted from the obfuscated claim set. If any of the corresponding claims of the first and second claims is found to be different with respect to the claim type or the claim value, the claim set may be ascertained to be invalid.

Upon determining the claim set to be valid, (‘Yes’ path from block 708), access to the protected data may be granted, at block 710. For granting access to the protected data, a grant signal may be sent to the first client application to allow the user to view the protected data through a user device, say the first user device 202. Once the first client application receives the grant signal from the server, the first client application may present the protected data on a display of the user device.

Upon determining the claim set to be invalid, (‘No’ path from block 708), access to the protected data may be restricted, at block 712. For restricting access to the specific protected data, a restrict signal may be sent to the first client application to prevent display of the protected data on the user device. Once the first client application receives the restrict grant signal from the server, the first client application may present an indication, depicting that the protected data cannot be accessed, to the user on the display of the user device. The present subject matter thus provides a dynamic approach that enables the server 102 to make real-time decisions about data access authorization quickly and efficiently.

FIG. 8 illustrates the method 800 for notifying one or more users to access protected data, according to an example.

At block 802, a notification issuance request may be received at a server, say the server 102 of the system 100, from a second client application controlled by the server. The notification issuance request may be issued by any entity that intends to notify one or more users about a specific event. For instance, an organization that has taken a recall decision to recall a particular product manufactured by the organization, may intend to notify specific stakeholders about the recall decision. The specific stakeholders may include customers, partners, suppliers, and regulatory bodies that may be affected due to the recall of the particular product and thus should be notified about the recall decision. Thus, an entity associated with the organization may issue the notification issuance request for notifying the specific stakeholders about the recall decision.

In an example, certain sensitive details about the specific event may only be accessed by the one or more users through a first client application, say the first client application 208. Thus, for accessing the certain sensitive details about the specific event, a user of the one or more users may need to establish a user session with the first client application. For instance, in case of the recall decision, details describing the particular product or a method for disposition of the particular product may be accessed by the one or more users by establishing a user session with the first client application. The entity may be hereinafter alternatively referred to as another entity or other entity associated with the user session. Therefore, the notification issuance request may be initiated by another entity associated with the user session to notify the one or more users to interact with the first client application for accessing information associated with a current context of interaction with the first client application. For example, in case of the recall decision, the information associated with the current context of the user's interaction with the first client application may be the details describing the particular product and the method for disposition of the particular product.

At block 804, contact information corresponding to each of the one or more users may be obtained. Examples of the contact information may include, but are not limited to, a phone number of the user and an email identified (ID) of the user. In an example, the contact information of the one or more users may be pre-stored in a memory, say the memory 218 of the server 102, and may be obtained from the memory. In another example, the contact information of the one or more users may be obtained from an external database that manages contact information of a plurality of users including the one or more users. For example, the external database may be a customer database associated with the organization that manages contact information of consignees of products, including the particular product, manufactured by the organization. In yet another example, the contact information of a subset of all of the one or more users may be obtained from respective user directly.

At block 806, a notification may be generated for transmission to the one or more users. The notification may include an information access link associated with the current context. The information access link may be a link that, when selected by a user may direct the user to the first client application by launching the first client application. That is, selection of the information access link within the notification launches the first client application for initiating access to the information about the current context. The information may include protected data, such as the sensitive information, that may be accessed once the user session is established with the first client application.

In an example, the notification may be transmitted to each of the one or more users using the corresponding contact information. For instance, the notification may be transmitted as a text message to each user of the one or more users through a short message service (SMS) on the corresponding phone number of the user. In another instance, the notification may be transmitted to each user of the one or more users as an email on the corresponding email ID of the user. In yet another instance, the notification may be transmitted to some of the one or more users using the SMS and the remaining of the one or more users using the email. While the SMS and the email have been used as examples for transmitting the notification, the notification may also be transmitted to the user using other type of commonly available messaging services.

FIG. 9A illustrates the method 900 for authenticating a session establishment request initiated for establishing a user session to access protected data, according to an example.

At block 902, a login request may be received from a user to login into a first client application, say the first client application 208. The login request may be triggered by the user to access the protected data. In one example, the login request may be received from the first client application when the user attempts to login into the first client application by clicking on an information access link received within a notification. The notification including the information access link may transmitted to the user by a server, say the server 102, using the method 800. In another example, the login request may be received from the first client application when the user directly attempts to login into the first client application without the information access link.

At block 904, a temporary code may be generated corresponding to the login request. The temporary code may be used by the user to login into the first client application. In an example, the temporary code may be a one-time password (OTP). The temporary code may be transmitted to the user for enabling the user to login into the first client application using the temporary code. The temporary code may be transmitted to the user, for example, through an SMS or an email, using the contact information corresponding to the user.

At block 906, login-specific data associated with the login request may be stored. In an example, the login-specific data may be stored in a memory, say the memory 218 of the server 102. The login-specific data may be used for authentication during establishment of the user session with the first client application. That is, the login-specific data may be used for authentication when the user attempts to establish the user session by attempting to login into the first client application after receiving the temporary code from the server.

The login-specific data may include at least one of the temporary code, contact information corresponding to the user, at least one session-specific attribute describing a current context of interaction with the first client application, and at least one login attribute describing the login request. For example, if the current context of interaction with the first client application is to access protected data related to a product recall initiated by an organization, the at least one session-specific attribute may include a product ID uniquely defining the product recall and a phase ID defining a phase of the product recall. Examples of the at least one login attribute may include, but are not limited to, a global location number (GLN) associated with a location from which the user triggered the login request and a particular IP address through which the user triggered the login request.

At block 908, a session establishment request may be received at the server from a user. The session establishment request may be a request for establishing the user session with the first client application. In an example, the session establishment request may be received when the user enters an access code into a login page of the first client application for authentication and establishment of the user session.

At block 910, it is ascertained whether the session establishment request is authentic. For ascertaining whether the session establishment request is authentic, an authentication process may be initiated. In an example, the authentication process is initiated before allowing the user to login into the first client application. The authentication process may be the method 910 of FIG. 9B.

Upon ascertaining the session establishment request to be unauthentic, (‘No’ path from block 910), initiating a session establishment process may be forgone, at block 912. The session establishment process may include establishing the user session by generating and transmitting an obfuscated claim set to the first client application, as discussed in previous Figures. Instead of initiating the session establishment process, an authentication failure signal may be sent to the first client application. The authentication failure signal may indicate that the user is not allowed to establish the user session with the first client application.

Upon ascertaining the session establishment request to be authentic, (‘Yes’ path from block 910), a session establishment process may be initiated, at block 914. For initiating the session establishment process, an obfuscated claim set may be generated and transmitted to the first client application, as discussed in previous Figures. The obfuscated claim set may be a dynamic, session-specific claim set that is meaningless to an outside observer, such as a malicious attacker, and is hard to predict or reuse. The obfuscated claim set may be used for data access authentication during the user session.

FIG. 9B illustrates the method 910 for ascertaining whether the session establishment request is authentic at block 910 of FIG. 9A, according to an example.

At block 916, request-specific data associated with the session establishment request may be obtained. The request-specific data may include at least one of the access code, contact information associated with the session establishment request, a session-specific attribute associated with the session establishment request, and a request attribute describing the session establishment request. The contact information associated with the session establishment request may be a particular contact information using which the session establishment request is triggered. The session-specific attribute may be an attribute describing a specific context of interaction with the first client application for which the user triggered the session establishment request. In one example, the session-specific attribute may include a specific product ID uniquely defining a specific product recall if the specific context of interaction with the first client application is to access protected data related to the specific product recall initiated by an organization. In addition, or alternately, the session-specific attribute may include a specific phase ID defining a phase of the specific product recall. Examples of the request attribute may include, but are not limited to, a specific global location number (GLN) associated with a particular location from which the user triggered the session establishment request and a specific IP address through which the user triggered the session establishment request.

At block 918, the request-specific data and the login-specific data may be analyzed to ascertain whether the session establishment request is authentic. In an example, the session establishment request may be ascertained to be authentic when the request-specific data is similar to the login-specific data. In an example, the session establishment request may be ascertained to be unauthentic when the request-specific data is different from the login-specific data. For example, if the temporary code is determined to be different than the access code, the session establishment request may be ascertained as a malicious attempt of logging into the first client application. In another example, if the temporary code is determined to be same as the access code, but the GLN associated with the login request is found to be substantially different than the specific GLN associated with the session establishment request, the session establishment request may be ascertained as a malicious attempt of logging into the first client application.

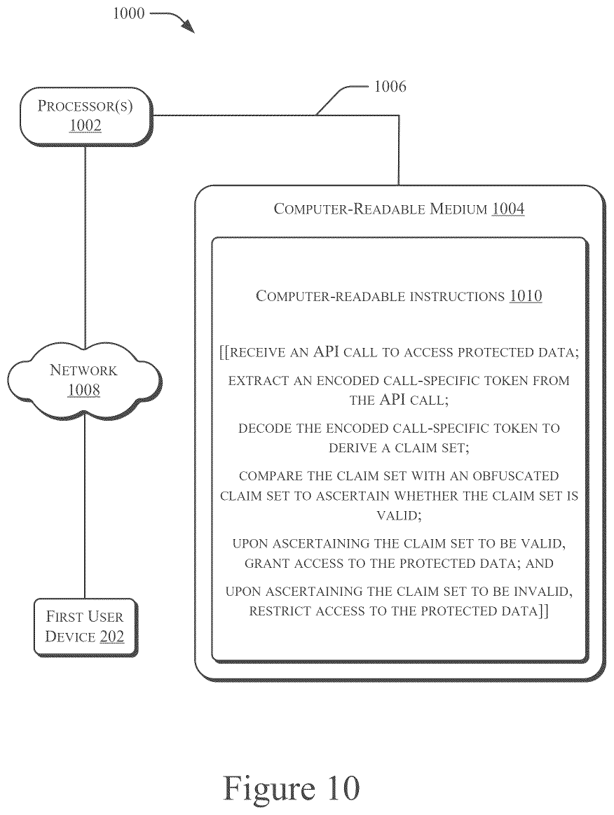

FIG. 10 illustrates a computing environment 1000 implementing a non-transitory computer-readable medium for data access authentication, according to an example. In an example, the computing environment 1000 includes processor(s) 1002 communicatively coupled to a non-transitory computer-readable medium 1004 through a communication link 1006. In one example, the communication link 1006 may be similar to the communication network 212, as described in conjunction with the preceding figures. In an example implementation, the computing environment 1000 may be for example, the computing environment 200 or 400. In an example, the processor(s) 1002 may have one or more processing resources for fetching and executing computer-readable instructions from the non-transitory computer-readable medium 1004. The processor(s) 1002 and the non-transitory computer-readable medium 1004 may be implemented, for example, in the server 102 of the system 100 (as has been described in conjunction with the preceding figures).

The non-transitory computer-readable medium 1004 may be, for example, an internal memory device or an external memory device. In an example implementation, the communication link 1006 may be a network communication link. The processor(s) 1002 and the non-transitory computer-readable medium 1004 may also be communicatively coupled to the first user device 202 over a network 1008. The network 1008 may be similar to the communication network 212 described in conjunction with FIG. 2.

In an example implementation, the non-transitory computer-readable medium 1004 may include a set of computer-readable instructions 1010 which may be accessed by the processor(s) 1002 through the communication link 1006. Referring to FIG. 10, in an example, the non-transitory computer-readable medium 1004 may include instructions 1010 that may cause the processor(s) 1002 to receive an application programming interface (API) call by a server, say the server 102 of the system 100. The API call may pertain to accessing of protected data during a user session established by a user with a first client application, say the first client application 208. User sessions established with the first client application may be controlled by the server. In an example, the particular API call may include a call-specific cookie including an encoded call-specific token. Example of the call-specific cookie may include, but is not limited to, a Hypertext Transfer Protocol Secure (Https) cookie. In an example, the encoded call-specific token may be an encoded form of a JavaScript Object Notation (JSON) Web Token (JWT).

The instructions 1010 may then cause the processor(s) 1002 to extract the encoded call-specific token from the call-specific cookie. In an example, the encoded call-specific token may be extracted from the call-specific cookie using commonly known token extraction techniques. The instructions 1010 may then cause the processor(s) 1002 to decode the encoded call-specific token to derive a claim set included in the encoded call-specific token. The claim set may contain specific claims to be used for authentication of the API call. For decoding the encoded call-specific token, a specific decoding technique, that corresponds to an encoding technique used to encode the call-specific token, may be utilized. In an example, the specific decoding technique may be any commonly known token deserialization technique.

The instructions 1010 may further cause the processor(s) 1002 to ascertain whether the claim set is valid. For ascertaining whether the claim set is valid, the instructions 1010 may cause the processor(s) 1002 to compare the claim set with an obfuscated claim set. The obfuscated claim set may be stored in a memory, say the memory 218 of the server 102, and may be obtained from the memory for comparison with the claim set for data access authentication. For example, the claim set may be ascertained to be valid if the claim set is determined to be same as the obfuscated claim set. The claim set may be ascertained to be invalid if the claim set is determined to be different than the obfuscated claim set.

For comparing the claim set with the obfuscated claim set, first claims may be extracted from the obfuscated claim set and second claims, i.e., the specific claims, may be extracted from the claim set. Corresponding claims of the first and second claims may be compared with each other to check whether corresponding claim types and corresponding claim values of the corresponding claims are same or different. For example, the obfuscated claim set may include three claims, where a first claim may pertain to a first claim type “user name” having a first claim value “user A”, a second claim may pertain to a second claim type “consignment delivery date” having a second claim value “date A”, and a third claim may pertain to a third claim type “recall ID” having a third claim value “ABCDEF”. Thus, the claim set may be ascertained to be valid when the second claims have three claims with the first, second, and third claim types having the first, second, and third claim values same as the three claims extracted from the obfuscated claim set. If any of the corresponding claims of the first and second claims is found to be different with respect to the claim type or the claim value, the claim set may be ascertained to be invalid.

Upon determining the claim set to be valid, the instructions 1010 may cause the processor(s) 1002 to grant access to the protected data. For granting access to the protected data, a grant signal may be sent to the first client application to allow the user to view the protected data through a user device, say the first user device 202. Once the first client application receives the grant signal from the server, the first client application may present the protected data on a display of the user device.

Upon determining the claim set to be invalid, the instructions 1010 may cause the processor(s) 1002 to restrict access to the protected data. For restricting access to the specific protected data, a restrict signal may be sent to the first client application to prevent display of the protected data on the user device. Once the first client application receives the restrict grant signal from the server, the first client application may present an indication, depicting that the protected data cannot be accessed, to the user on a display of the user device.

In an example, for notifying one or more users, including the user, to access the protected data, the instructions 1010 may cause the processor(s) 1002 to receive a notification issuance request at the server from a second client application, say the second client application 210. The notification issuance request may be issued by any entity that intends to notify one or more users about a specific event. For instance, an organization that has taken a recall decision to recall a particular product manufactured by the organization, may intend to notify specific stakeholders about the recall decision. The specific stakeholders may include customers, partners, suppliers, and regulatory bodies that may be affected due to the recall of the particular product and thus should be notified about the recall decision. Thus, an entity associated with the organization may issue the notification issuance request for notifying the specific stakeholders about the recall decision.

In an example, certain sensitive details about the specific event may only be accessed by the one or more users through the first client application. Thus, for accessing the certain sensitive details about the specific event, a user of the one or more users may need to establish the user session with the first client application. For instance, in case of the recall decision, details describing the particular product or a method for disposition of the particular product may be accessed by the one or more users by establishing a user session with the first client application. The entity may be hereinafter alternatively referred to as another entity or other entity associated with the user session. Therefore, the notification issuance request may be initiated by another entity associated with the user session to notify the one or more users to interact with the first client application for accessing information associated with a current context of interaction with the first client application. For example, in case of the recall decision, the information associated with the current context of the user's interaction with the first client application may be the details describing the particular product and the method for disposition of the particular product.

The instructions 1010 may further cause the processor(s) 1002 to obtain contact information corresponding to each of the one or more users. Examples of the contact information may include, but are not limited to, a phone number of the user and an email identified (ID) of the user. In an example, the contact information of the one or more users may be pre-stored in a memory, say the memory 218 of the server 102, and may be obtained from the memory. In another example, the contact information of the one or more users may be obtained from an external database that manages contact information of a plurality of users including the one or more users. For example, the external database may be a customer database associated with the organization that manages contact information of consignees of products, including the particular product, manufactured by the organization. In yet another example, the contact information of a subset of all of the one or more users may be obtained from respective user directly.

The instructions 1010 may further cause the processor(s) 1002 to generate a notification for transmission to the one or more users. The notification may include an information access link associated with the current context. The information access link may be a link that, when selected by a user may direct the user to the first client application by launching the first client application. That is, selection of the information access link within the notification launches the first client application for initiating access to the information about the current context. The information may include protected data, such as the sensitive information, that may be accessed once the user session is established with the first client application.

In an example, the notification may be transmitted to each of the one or more users using the corresponding contact information. For instance, the notification may be transmitted as a text message to each user of the one or more users through a short message service (SMS) on the corresponding phone number of the user. In another instance, the notification may be transmitted to each user of the one or more users as an email on the corresponding email ID of the user. In yet another instance, the notification may be transmitted to some of the one or more users using the SMS and the remaining of the one or more users using the email. While the SMS and the email have been used as examples for transmitting the notification, the notification may also be transmitted to the user using other type of commonly available messaging services. Upon receiving the notification, a user may attempt to login into the first client application using the information access link. Alternatively, the user may attempt to login into the first client application without receiving the notification or the information access link.

In an example, the instructions 1010 may cause the processor(s) 1002 to receive a login request from the user to login into the first client application. In one example, the login request may be received from the first client application when the user attempts to login into the first client application by clicking on the information access link received within the notification. In another example, the login request may be received from the first client application when the user directly attempts to login into the first client application without the information access link.

Upon receiving the login request, the instructions 1010 may cause the processor(s) 1002 to generate a temporary code corresponding to the login request. The temporary code may be used by the user to login into the first client application. In an example, the temporary code may be a one-time password (OTP). The instructions 1010 may further cause the processor(s) 1002 to transmit the temporary code to the user for enabling the user to login into the first client application using the temporary code. The temporary code may be transmitted to the user, for example, through an SMS or an email, using the contact information corresponding to the user.

In addition to providing the temporary code to the user, the instructions 1010 may cause the processor(s) 1002 to store login-specific data associated with the login request. In an example, the login-specific data may be stored in the memory. The login-specific data may be used for authentication during establishment of the user session with the first client application. That is, the login-specific data may be used for authentication when the user attempts to establish the user session by attempting to login into the first client application after receiving the temporary code from the server.

The login-specific data may include at least one of the temporary code, the contact information corresponding to the user, at least one session-specific attribute describing the current context of interaction with the first client application, and at least one login attribute describing the login request. For example, if the current context of interaction with the first client application is to access protected data related to a product recall initiated by an organization, the at least one session-specific attribute may include a product ID uniquely defining the product recall and a phase ID defining a phase of the product recall. Examples of the at least one login attribute may include, but are not limited to, a global location number (GLN) associated with a location from which the user triggered the login request and a particular IP address through which the user triggered the login request.

In an example, the instructions 1010 may cause the processor(s) 1002 to a session establishment request from the user. The session establishment request may be a request for establishing the user session with the first client application. In an example, the session establishment request may be received when the user enters an access code into a login page of the first client application for authentication and establishment of the user session. Upon receiving the session establishment request, the instructions 1010 may cause the processor(s) 1002 to initiate an authentication process to ascertain whether the session establishment request is authentic. The authentication process may be initiated before allowing the user to login into the first client application.

In an example, during the authentication process, the instructions 1010 may cause the processor(s) 1002 to obtain request-specific data associated with the session establishment request. The request-specific data may include at least one of the access code, contact information associated with the session establishment request, a session-specific attribute associated with the session establishment request, and a request attribute describing the session establishment request. The contact information associated with the session establishment request may be a particular contact information using which the session establishment request is triggered. The session-specific attribute may be an attribute describing a specific context of interaction with the first client application for which the user triggered the session establishment request. In one example, the session-specific attribute may include a specific product ID uniquely defining a specific product recall if the specific context of interaction with the first client application is to access protected data related to the specific product recall initiated by an organization. In addition, or alternately, the session-specific attribute may include a specific phase ID defining a phase of the specific product recall. Examples of the request attribute may include, but are not limited to, a specific global location number (GLN) associated with a particular location from which the user triggered the session establishment request and a specific IP address through which the user triggered the session establishment request.

The instructions 1010 may further cause the processor(s) 1002 to analyze the request-specific data and the login-specific data to ascertain whether the session establishment request is authentic. In an example, the session establishment request may be ascertained to be authentic when the request-specific data is similar to the login-specific data. In an example, the session establishment request may be ascertained to be unauthentic when the request-specific data is different from the login-specific data. For example, if the temporary code is determined to be different than the access code, the session establishment request may be ascertained as a malicious attempt of logging into the first client application. In another example, if the temporary code is determined to be same as the access code, but the GLN associated with the login request is found to be substantially different than the specific GLN associated with the session establishment request, the session establishment request may be ascertained as a malicious attempt of logging into the first client application.

Upon ascertaining the session establishment request to be authentic, the instructions 1010 may cause the processor(s) 1002 to obtain a set of attributes corresponding to the user session requested to be established by the user with the first client application. In one example, the set of attributes may be pre-stored in the memory and may be obtained from the memory. In another example, the set of attributes may be obtained from external sources, such as the user, the other entity associated with the user session, or an external database within which confidential information pertaining to the user or the user session may be stored.

The set of attributes may include at least one of one or more user-specific attributes, one or more session-specific attributes, and one or more historical attributes. The one or more user-specific attributes may be attributes describing the user. Examples of the one or more user-specific attributes may include, but are not limited to, a name of the user, a global location number (GLN) associated with the user, a phone number of the user, and an email identifier (ID) of the user. The session-specific attributes may be attributes describing a current context of user's interaction with the first client application. For instance, if the user session pertains to accessing of information about a product recall initiated by an organization, examples of the session-specific attributes may include, but are not limited to, a product recall ID, a phase ID defining a phase of the product recall, a current IP address through which the user session is requested to be established, or a current type of device through the user session is requested to be established. The historical attributes may be confidential attributes historically provided to the server by the user or another entity, such as a manufacturer of a product in case of the product recall, associated with the user session. Examples of the historical attributes may include, but are not limited to, a regulatory submission number that is a confidential information received from regulatory bodies, or a product delivery date on which a product corresponding to a product recall was delivered to the user. Thus, the set of attributes is a comprehensive, diverse, nuanced, and context-aware attribute set.

Once the set of attributes is obtained, the instructions 1010 may cause the processor(s) 1002 to derive the obfuscated claim set corresponding to the user session based on the set of attributes. In an example, the obfuscated claim set may be derived by encoding or encrypting the set of attributes into a format that is not easily interpretable by unauthorized parties. The obfuscated claim set may be unique to the user session. The obfuscated claim set may be unique to the user session. Thus, the obfuscated claim set may be a dynamic, session-specific claim set that is meaningless to an outside observer, such as a malicious attacker, and is hard to predict or reuse. The obfuscated claim set is to be provided to the first client application for being used for data access authentication during the user session. That is, once the obfuscated claim set are provided to the first client application, for every subsequent data access request during the user session, the first client application must share a claim set, that is same as the obfuscated claim set, with the server for successful authentication by the server to gain access to requested data.

For providing the obfuscated claim set to the first client application, the instructions 1010 may cause the processor(s) 1002 to generate a session-specific token corresponding to the user session. The session-specific token may incorporate the obfuscated claim set. In an example, the session-specific token may be a JavaScript Object Notation (JSON) Web Token (JWT). The instructions 1010 may further cause the processor(s) 1002 to encode the session-specific token to generate an encoded session-specific token. The session-specific token may be encoded using standard encoding techniques to ensure safe transmission of the session-specific token to the first client application. For ensuring secure transmission of the session-specific token, the instructions 1010 may further cause the processor(s) 1002 to further embed the encoded session-specific token within a session cookie for transmission to the first client application. Example of the session cookie may include, but is not limited to, a Hypertext Transfer Protocol Secure (Https) cookie. The session cookie may then be transmitted to the first client application to securely provide the obfuscated claim set to the first client application. The session-specific token within the session cookie may be utilized by the first client application for generating call-specific tokens for data access authentication during the user session.

For every application programming interface (API) call received at the server from the first client application to access protected data during the user session, the instructions 1010 may cause the processor(s) 1002 to control access to the protected data based on a comparison of a claim set received within the API call with the obfuscated claim set. For example, if the claim set is determined to be same as the obfuscated claim set based on the comparison, the instructions 1010 may cause the processor(s) 1002 to grant access to the protected data. Further, if the claim set is determined to be different than the obfuscated claim set based on the comparison, the instructions 1010 may cause the processor(s) 1002 to restrict access to the protected data.

The present subject matter thus provides a dynamic approach that enables the server to make real-time decisions about data access authorization quickly and efficiently.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

We claim:

1. A system comprising:
a server configured to control user sessions established with a first client application, the server comprising:
a token generation engine to:
obtain a set of attributes corresponding to a user session requested to be established by a user with the first client application, the set of attributes including at least one of:
one or more user-specific attributes,
one or more session-specific attributes, and
one or more historical attributes; and
derive an obfuscated claim set corresponding to the user session based on the set of attributes, wherein the obfuscated claim set is unique to the user session, and wherein the obfuscated claim set is to be provided to the first client application for being used for data access authentication during the user session; and
an authentication engine to:
for every application programming interface (API) call received from the first client application to access protected data during the user session, controlling access to the protected data based on a comparison of a claim set received within the API call with the obfuscated claim set.

2. The system of claim 1, wherein the token generation engine is to:
generate, corresponding to the user session, a session-specific token incorporating the obfuscated claim set;
encode the session-specific token to generate an encoded session-specific token; and
embed the encoded session-specific token within a session cookie for transmission to the first client application.

3. The system of claim 1, wherein the server comprises:
a login authorization engine to:
receive a session establishment request from the user to establish the user session with the first client application; and
initiate an authentication process to ascertain whether the session establishment request is authentic, wherein the set of attributes is obtained by the token generation engine upon ascertaining the session establishment request to be authentic.

4. The system of claim 1, wherein the server is configured to control a second client application, and wherein the server comprises:
a notification generation engine to:
receive a notification issuance request from the second client application, wherein the notification issuance request is initiated by another entity associated with the user session to notify one or more users, including the user, to interact with the first client application for accessing information associated with a current context of interaction with the first client application;
obtain contact information corresponding to each of the one or more users; and
generate a notification including an information access link associated with the current context, wherein the notification is transmitted to each of the one or more users using the corresponding contact information, and wherein selection of the information access link within the notification launches the first client application for initiating access to the information about the current context, wherein the information includes the protected data.

5. The system of claim 1, wherein the server comprises:
a login authorization engine to:
receive a login request from the user to login into the first client application;
generate a temporary code corresponding to the login request, wherein the temporary code is to be used by the user to login into the first client application; and
store login-specific data associated with the login request, wherein the login-specific data is to be used for authentication during establishment of the user session, and wherein the login-specific data includes at least one of:
the temporary code,
contact information corresponding to the user,
at least one session-specific attribute describing a current context of interaction with the first client application, and
at least one login attribute describing the login request.

6. The system of claim 5, wherein the login authorization engine is to:
receive a session establishment request from the user to establish the user session with the first client application, wherein the session establishment request includes an access code;
obtain request-specific data associated with the session establishment request, wherein the request-specific data includes at least one of:
the access code,
contact information associated with the session establishment request,
a session-specific attribute associated with the session establishment request, and
a request attribute describing the session establishment request; and
analyze the request-specific data and the login-specific data to ascertain whether the session establishment request is authentic, wherein the set of attributes is obtained by the token generation engine upon ascertaining the session establishment request to be authentic.

7. The system of claim 1, wherein the authentication engine is to:
receive a particular API call to access specific protected data during the user session, wherein the particular API call includes a call-specific cookie including an encoded call-specific token;
extract the encoded call-specific token from the call-specific cookie;
decode the encoded call-specific token to derive a particular claim set included in the encoded call-specific token;
compare the particular claim set with the obfuscated claim set to ascertain whether the particular claim set is valid;
upon ascertaining the particular claim set to be valid, grant access to the specific protected data; and
upon ascertaining the particular claim set to be invalid, restrict accessing to the specific protected data.

8. A method comprising:
receiving, at a server, a session establishment request from a user to establish a user session with a first client application, user sessions established with the first client application being controlled by the server;
deriving, by the server, an obfuscated claim set corresponding to the user session based on at least one of:
one or more user-specific attributes,
one or more session-specific attributes, and
one or more historical attributes;
generating, by the server, corresponding to the user session, a session-specific token incorporating the obfuscated claim set;
embedding, by the server, the session-specific token within a session cookie for transmission to the first client application, wherein the session-specific token is to be utilized by the first client application for generating call-specific tokens for data access authentication during the user session; and
for every application programming interface (API) call received from the first client application to access protected data during the user session, controlling, by the server, access to the protected data based on a comparison of a claim set included in a call-specific token received within the API call with the obfuscated claim set.

9. The method of claim 8, wherein the method comprises:
receiving a notification issuance request from a second client application controlled by the server, wherein the notification issuance request is initiated by another entity associated with the user session to notify one or more users, including the user, to interact with the first client application for accessing information associated with a current context of interaction with the first client application;
obtaining contact information corresponding to each of the one or more users; and
generating a notification including an information access link associated with the current context, wherein the notification is transmitted to each of the one or more users using the corresponding contact information, and wherein selection of the information access link within the notification launches the first client application for initiating access to the information about the current context, wherein the information includes the protected data.

10. The method of claim 8, wherein the method comprises:
receiving a login request from the user to login into the first client application;
generating a temporary code corresponding to the login request, wherein the temporary code is to be used by the user to login into the first client application; and
storing login-specific data associated with the login request, wherein the login-specific data is to be used for authentication during establishment of the user session, and wherein the login-specific data includes at least one of:
the temporary code,
contact information corresponding to the user,
at least one session-specific attribute describing a current context of interaction with the first client application, and
at least one login attribute describing the login request.

11. The method of claim 10, wherein the method comprises:
initiating an authentication process to ascertain whether the session establishment request is authentic, wherein the obfuscated claim set is derived upon ascertaining the session establishment request to be authentic.

12. The method of claim 11, wherein the session establishment request includes an access code, and wherein the authentication process includes:
obtaining request-specific data associated with the session establishment request, wherein the request-specific data includes at least one of:
the access code,
contact information associated with the session establishment request,
a session-specific attribute associated with the session establishment request, and
a request attribute describing the session establishment request; and
analyzing the request-specific data and the login-specific data to ascertain whether the session establishment request is authentic.

13. The method of claim 8, wherein the method comprises:
encoding the session-specific token to generate an encoded session-specific token, wherein embedding the session-specific token within the session cookie comprises embedding the encoded session-specific token within the session cookie.

14. The method of claim 8, wherein the method comprises:
receiving a particular API call to access specific protected data during the user session, wherein the particular API call includes a call-specific cookie including an encoded call-specific token;
extracting the encoded call-specific token from the call-specific cookie;
decoding the encoded call-specific token to derive a particular claim set included in the encoded call-specific token;
comparing the particular claim set with the obfuscated claim set to ascertain whether the particular claim set is valid;
upon ascertaining the particular claim set to be valid, granting access to the specific protected data; and
upon ascertaining the particular claim set to be invalid, restricting accessing to the specific protected data.

15. A non-transitory computer-readable medium comprising instructions for data access authentication, the instructions being executable by a processing resource to:
receive, by a server, an application programming interface (API) call to access protected data during a user session established by a user with a first client application, user sessions established with the first client application being controlled by the server;
extract an encoded call-specific token from the API call;
decode the encoded call-specific token to derive a claim set included in the encoded call-specific token;
compare the claim set with an obfuscated claim set to ascertain whether the claim set is valid, wherein the obfuscated claim set is generated and transmitted by the server to the first client application during establishment of the user session, wherein the obfuscated claim set is generated based on at least one of:
one or more user-specific attributes,
one or more session-specific attributes, and
one or more historical attributes;
upon ascertaining the claim set to be valid, grant access to the protected data; and
upon ascertaining the claim set to be invalid, restrict access to the protected data.

16. The non-transitory computer-readable medium of claim 15, wherein the instructions are executable by the processing resource to:
receive a session establishment request from the user to establish the user session with the first client application;
initiate an authentication process to ascertain whether the session establishment request is authentic; and
upon ascertaining the session establishment request to be authentic, derive the obfuscated claim set corresponding to the user session.

17. The non-transitory computer-readable medium of claim 15, wherein the instructions are executable by the processing resource to:
generate, corresponding to the user session, a session-specific token incorporating the obfuscated claim set;
encode the session-specific token to generate an encoded session-specific token; and
embed the encoded session-specific token within a session cookie for transmission to the first client application, wherein the session-specific token is to be utilized by the first client application for generating call-specific tokens for data access authentication during the user session.

18. The non-transitory computer-readable medium of claim 15, wherein the instructions are executable by the processing resource to:
receive a notification issuance request from a second client application controlled by the server, wherein the notification issuance request is initiated by another entity associated with the user session to notify one or more users, including the user, to interact with the first client application for accessing information associated with a current context of interaction with the first client application;
obtain contact information corresponding to each of the one or more users; and
generate a notification including an information access link associated with the current context, wherein the notification is transmitted to each of the one or more users using the corresponding contact information, and wherein selection of the information access link within the notification launches the first client application for initiating access to the information about the current context, wherein the information includes the protected data.

19. The non-transitory computer-readable medium of claim 15, wherein the instructions are executable by the processing resource to:
receive a login request from the user to login into the first client application;
generate a temporary code corresponding to the login request, wherein the temporary code is to be used by the user to login into the first client application; and
store login-specific data associated with the login request, wherein the login-specific data is to be used for authentication during establishment of the user session, and wherein the login-specific data includes at least one of:
the temporary code,
contact information corresponding to the user,
at least one session-specific attribute describing a current context of interaction with the first client application, and
at least one login attribute describing the login request.

20. The non-transitory computer-readable medium of claim 19, wherein the instructions are executable by the processing resource to:
receive a session establishment request from the user to establish the user session with the first client application, wherein the session establishment request includes an access code;
obtain request-specific data associated with the session establishment request, wherein the request-specific data includes at least one of:
the access code,
contact information associated with the session establishment request,
a session-specific attribute associated with the session establishment request, and
a request attribute describing the session establishment request;
analyze the request-specific data and the login-specific data to ascertain whether the session establishment request is authentic; and
upon ascertaining the session establishment request to be authentic, generate the obfuscated claim.
